(19) United States
(12) Patent Application Publication
(10) Pub. No.: US 2011/0070566 A1
(43) Pub. Date: Mar. 24, 2011

(54) Meal Planning System

(76) Inventors: Malgorzata HANULAK, Birmingham, MI (US); Agnieszka HANULAK, Birmingham, MI (US)

(21) Appl. No.: 12/886,783

(22) Filed: Sep. 21, 2010

Related U.S. Application Data
(60) Provisional application No. 61/244,108, filed on Sep. 21, 2009.

(51) Int. Cl. G09B 19/00

(52) U.S. Cl. 434/127

(57) ABSTRACT

A meal planning system may include first, second and third grocery lists, a plurality of first recipes and a plurality of second recipes. The second grocery list may be associated with the first grocery list. The first recipes may be associated with the second grocery list. Each of the first recipes may include food items from at least one of the first and second grocery lists. The second grocery list includes enough food items to prepare the first recipes. The third grocery list may be associated with the first grocery list. The second recipes may be associated with the third grocery list. Each of the second recipes may include food items from at least one of the first and third grocery lists. The third grocery list includes enough food items to prepare the second recipes. The grocery lists and recipes may be displayed on cards and/or an electronic device.

### CROSS-REFERENCE TO RELATED APPLICATIONS

This application claims the benefit of U.S. Provisional Application No. 61/244,108, filed on Sep. 21, 2009. The entire disclosure of the above application is incorporated herein by reference.

### FIELD

The present teachings relate to a meal planning, shopping and diet control system and specifically relate to a meal planning system that can be carried with the user, used to generate shopping lists, purchase food, and aid in the preparation of meals.

### BACKGROUND

This section provides background information related to the present disclosure and is not necessarily prior art.

Many people lack the time or desire to plan healthy and balanced meals for themselves and/or family members. Many of the readily available and convenient meal options such as carryout or fast foods can be expensive and unhealthy. Furthermore, many restaurants tend to provide large portion sizes, leading to overeating and/or wasted food and money. The present disclose provides convenient, health-conscious and economically sound solutions to these and other problems.

### SUMMARY

This section provides a general summary of the disclosure, and is not a comprehensive disclosure of its full scope or all of its features.

In one form, the present disclosure provides a meal planning kit generally having a connector member and cover members. Each of the cover members has a front portion defining a first aperture and a first pair of apertures each formed through the front portion and a back portion defining a second aperture and a second pair of apertures each formed through the back portion. The first aperture on the front portion and the second aperture on the back portion accept the connecter member. The meal planning kit further includes meal planning cards and elastic band members. The meal planning cards have a monthly subset of planning cards. The monthly subset of planning cards includes a first portion of the monthly subset of planning cards that provides a monthly shopping list. A second portion of the monthly subset of planning cards provides weekly shopping lists. A third portion of the monthly subset of planning cards provides meal information. A fourth portion of the monthly subset of planning cards provides images associated with the meal information from the meal planning cards in the third portion of the monthly subset. Each of the elastic band members have a first end and a second end between which is an elastic member. One of the elastic band members is operable to secure to the front portion of the cover member at the first pair of apertures and hold the meal planning card to the front portion. The first portion and the second portion of each of the cover members are operable to secure to one another and at least partially encapsulate the meal planning card held by the elastic member.

In another form, the present disclosure provides a system that may include a plurality of subsets of meal planning cards. Each of the subsets of meal planning cards may correspond to one of a plurality of predetermined time periods and may include a first card and a plurality of second cards. The first card may include a first list of food items corresponding to the one of the predetermined time periods. Each of the second cards may include one of a plurality of recipes corresponding to one of a plurality of meals during the one of the predetermined time periods. The one of the plurality of recipes may include at least one of the food items from the first list of food items. In some configurations, preparation of all of the plurality of recipes associated with all of the plurality of second cards may consume all of the food items from the first list of food items.

In yet another form, the present disclosure provides a meal planning system that may include a stock-item grocery list, a first subset of cards, and a second subset of cards. The first subset of cards may include a first multi-day grocery list and a plurality of first meal cards associated with the first multi-day grocery list. Each of the first meal cards may include one of a first plurality of recipes that include food items from at least one of the stock-item grocery list and the first multi-day grocery list. The first multi-day grocery list may list enough food items to prepare the recipes on all of the first meal cards. The second subset of cards may include a second multi-day grocery list and a plurality of second meal cards associated with the second multi-day grocery list. Each of the second meal cards may include one of a second plurality of recipes that may include food items from at least one of the stock-item grocery list and the second multi-day grocery list. The second multi-day grocery list may list enough food items to prepare the recipes on all of the second meal cards.

In still another form, the present disclosure provides a method that may include acquiring a plurality of first food items listed on a first card, acquiring a plurality of second food items listed on a second card corresponding to a first predetermined time period, and acquiring a plurality of third food items listed on a third card corresponding to a second predetermined time period. A plurality of first meals may be prepared from corresponding first recipes prior to acquiring the plurality of third food items. Each of the first recipes may be printed on a corresponding one of a plurality of fourth cards. The first recipes may include at least one of the second food items and at least one of the first food items. Each of the fourth cards may be associated with the first predetermined time period. A plurality of second meals may be prepared from corresponding second recipes. Each of the second recipes may be printed on a corresponding one of a plurality of fifth cards. The second recipes may include at least one of the third food items and at least one of the first food items. Each of the fifth cards may be associated with the second predetermined time period. A meal planning kit may be provided prior to acquiring the pluralities of first, second and third food items. The meal planning kit may include the first card, the second card, the third card, the fourth card, and the fifth card.

In still another form, the present disclosure provides a system that may include first, second and third grocery lists, a plurality of first recipes and a plurality of second recipes. The second grocery list may be associated with the first grocery list. The plurality of first recipes may be associated with the second grocery list. Each of the first recipes may include food items from at least one of the first and second grocery lists. The second grocery list may list enough food items to prepare the first recipes. The third grocery list may be associated with the first grocery list. The plurality of second recipes may be associated with the third grocery list. Each of the second recipes may include food items from at least one of the first and third grocery lists. The third grocery list may list enough food items to prepare the second recipes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected examples and not all possible aspects of the present teachings, and are not intended to limit the scope of the present disclosure.

FIG. 1 is a front view of an open connector member and a closed connector member that can each hold multiple meal planning cards in accordance with the present teachings;

FIG. 2 is a diagram of a portion of a meal planner kit including a front portion and a rear portion of a cover member connected to one another with one of the connector members and also including elastic band members in accordance with the present teachings;

FIG. 3 is a diagram of two elastic band members that can be secured to eyelets of the cover member of FIG. 2 in accordance with the present teachings;

FIG. 4 is a front view of one of the meal planning cards showing an aperture formed through the meal planning card that can accommodate one or more of the connector members in accordance with the present teachings;

FIG. 5 is similar to FIG. 4 and shows a rear view of the meal planning card in accordance with the present teachings;

FIG. 6 is a front view of an open connector member, a closed connector member, and locking member to hold multiple meal planning cards in accordance with another example of the present teachings;

FIG. 7 is a diagram of a portion of a meal planner kit including a front portion and a rear portion of a cover member connected to one another with one of the connector members and also including elastic band members in accordance with another example of the present teachings;

FIG. 8A is perspective view of a meal planner kit including a plurality of meal planning cards according to the principles of the present disclosure;

FIG. 8B is a perspective view of one of the meal planning cards of FIG. 8A;

FIG. 8C is a perspective view of another of the meal planning cards of FIG. 8A; and

FIG. 8D is a perspective view of yet another of the meal planning cards of FIG. 8A.

FIG. 9A is a perspective view of an electronic device displaying one of the meal planning cards;

FIG. 9B is a front view of the electronic device displaying another of the meal planning cards;

FIG. 9C is a front view of the electronic device displaying another of the meal planning cards;

FIG. 10 is a flowchart illustrating operation of a program operable on the electronic device; and

FIG. 11 is a schematic view of an order form adapted to be displayed on the electronic device.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

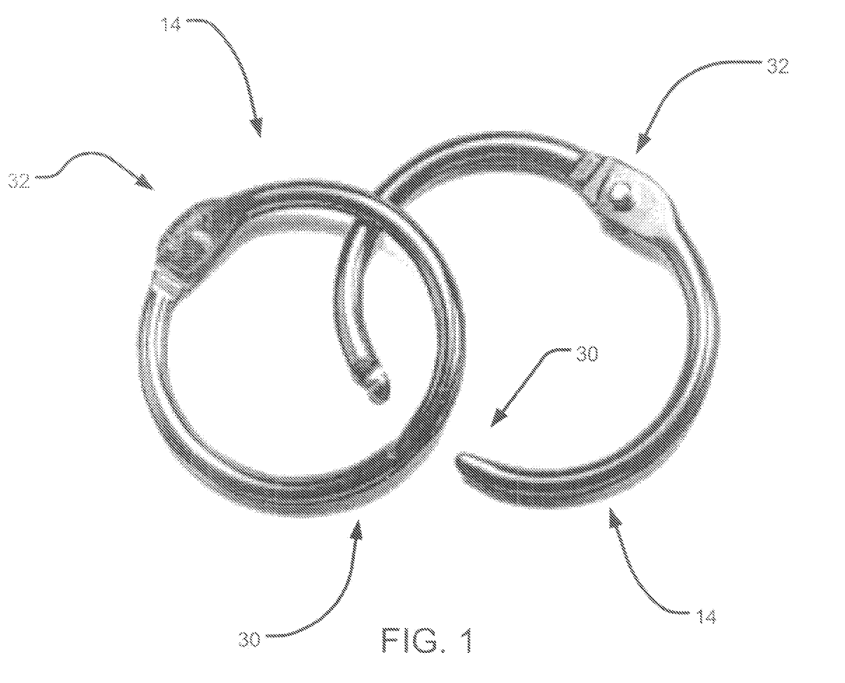

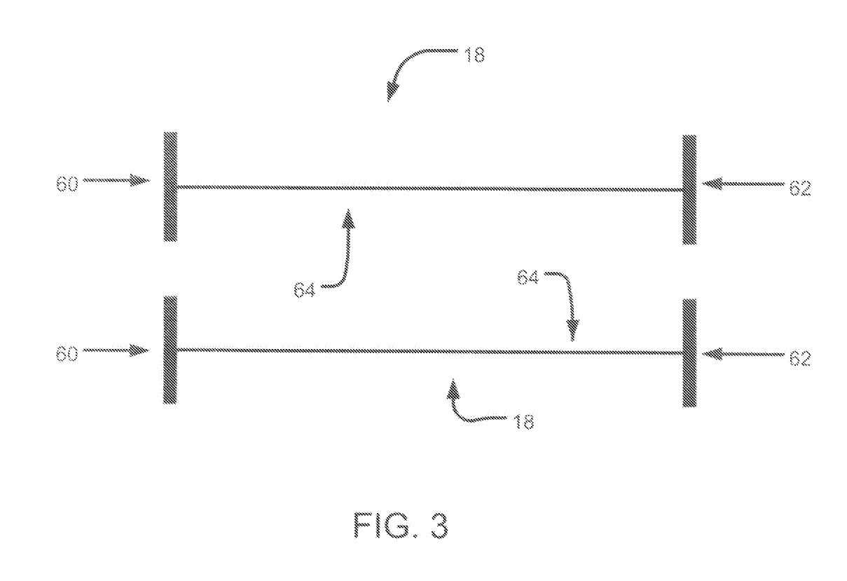

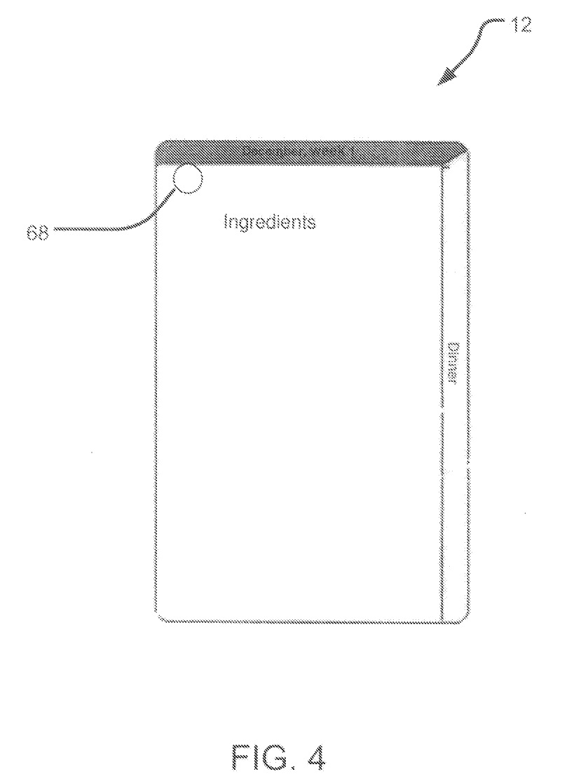

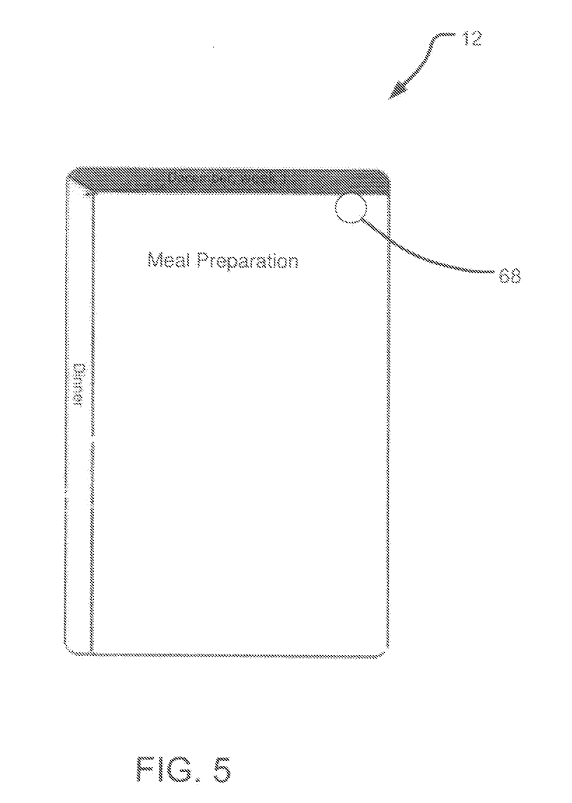

With reference to FIGS. 1-8D, the present disclosure provides a meal planner system 10 that may include multiple meal planning cards 12 that can be shown to make shopping and cooking experiences for a user quicker, easier, more convenient, healthier, and/or less expensive. The meal planner system 10 can generally include connector members 14, cover members 16, band members 18, and the multiple meal planning cards 12. It should be appreciated that the term “meal planning card,” as it is used throughout the present disclosure can include or refer to sheets of material such as paper, cardboard, plastic, wood and/or metal, for example, as well as a computer screen view or display of information and/or a computer-generated view or display of information.

With reference to FIG. 1, one of the connector members 14 can hold all of the meal planning cards 12 in the meal planner system 10 together (or a portion thereof) and can be relatively convenient for the user to open and close. One of the connector members 14 can be sized to only hold one week's worth of meal planning cards 12. In other examples, one month's worth of meal planning cards 12 can be held by one of the connector members 14.

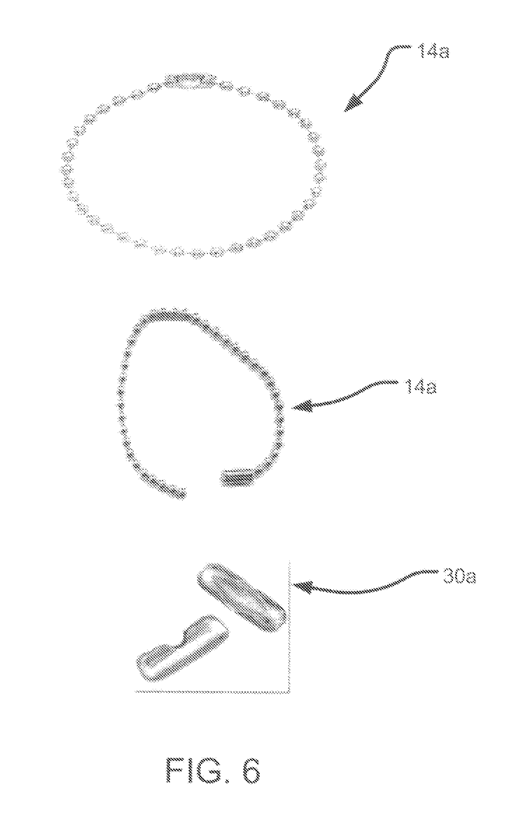

With reference to FIG. 6, a connector member 14a can also be provided in many sizes to accept one or more of the meal planning cards 12. In addition, the connector member 14a can be opened and closed with a locking portion 30a. In this example, the connector member 14a is a loop of consecutive ball members that can be selectively connected with the locking portion 30a to create differently sized connector members 14a. It will be appreciated in light of the disclosure that the connector member 14 and the connector member 14a can be used interchangeably throughout the disclosure as applicable.

The connector member 14 can also permit the meal planning cards 12 to be relatively easily scrolled through by the user when the meal planning cards 12 are connected to the connector member 14. The connector member 14 can permit the user to easily hold and flip through all of the meal planning cards 12, or a select sub-set of the meal planning cards 12. Unlike the example of the connector member 14a in FIG. 6, the connector member 14 can be one or more split key rings of various sizes to accommodate different sized sets of the meal planning cards 12, as illustrated in FIG. 1.

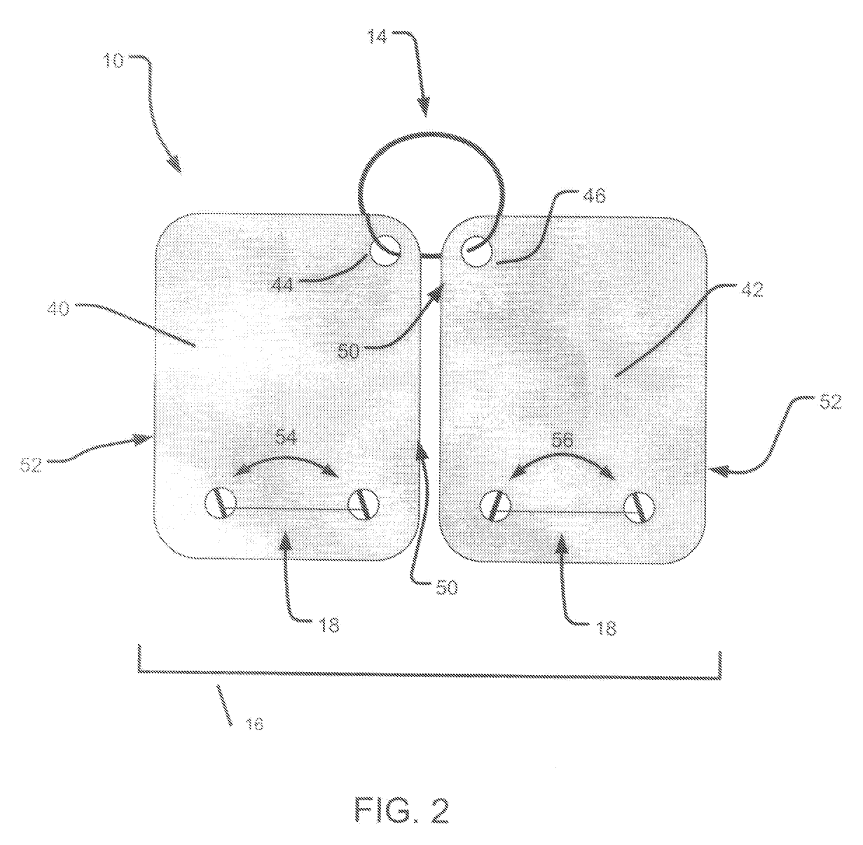

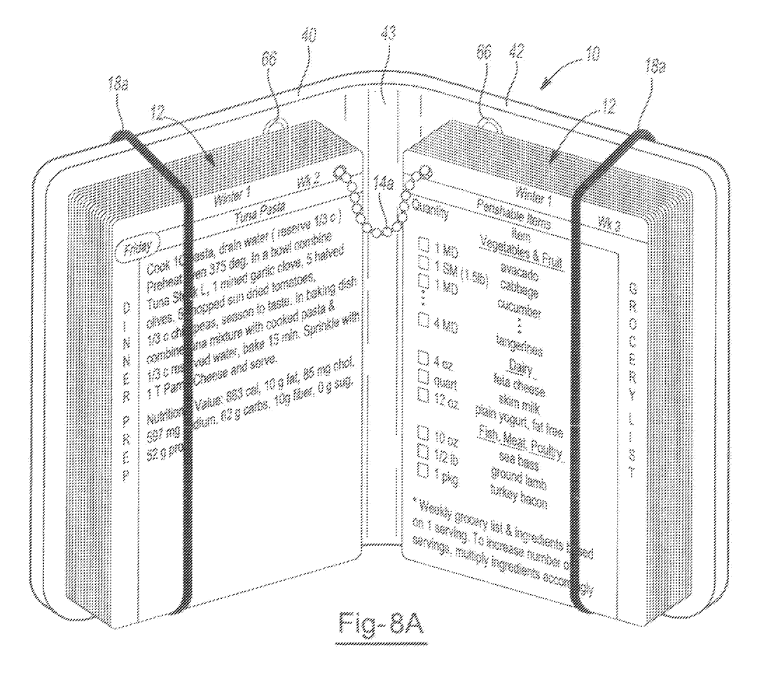

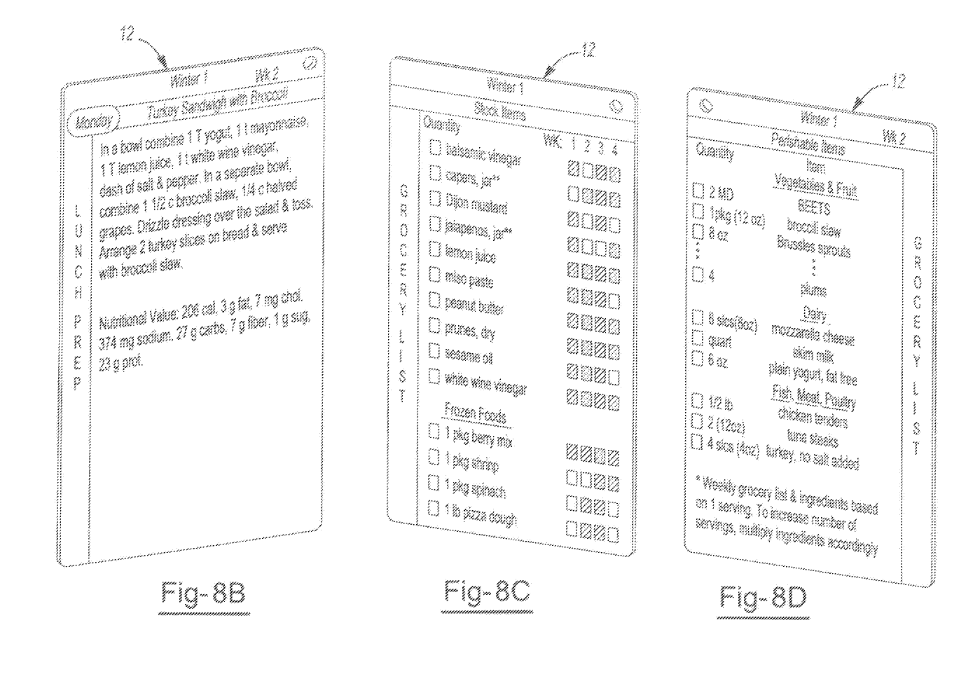

With reference to FIG. 2, the cover members 16 can each include a front cover portion 40 and a rear cover portion 42 that can be joined together to accommodate and encapsulate (partially or wholly) one of the meal planning cards 12. In one example, the meal planning cards 12 can be about 3.5 inches by about 2.5 inches (about 88.9 mm by about 63.5 mm). The cover members 16 can each have an aperture 44, 46 that can be formed through the front and rear cover portions 40, 42 of the cover members 16 and can be sized to accommodate one or more of the connector members 14. The apertures 44, 46 can be located in an upper corner and on a side 50 of the cover member 16 that can be opposite of a side 52 that can accommodate the band members 18. In some configurations, the front and rear cover portions 40, 42 may be connected to a central portion 43 (FIG. 8A) disposed therebetween. The central portion 43 may be foldable to allow the front and rear cover portions 40, 42 to move relative to each other between open and closed positions.

There are additionally two pairs of apertures 54, 56 formed through the front cover portion 40 and through the rear cover portion 42 of the cover member 16. The apertures 54, 56 can be sized to hold post members 62 of the band members 18. The post members 62 are connected by an elastic member 64 to provide, for example, the fastening capability of the band members 18 to the cover members 16. In this example, the pair of apertures 54 can be formed on the front cover portion 40 of one of the cover members 16 to hold one of the band members 18, and the pair of apertures 56 can be formed on the rear cover portion 42 of the cover member 16 to also hold one of the band members 18. Magnetic members can hold the front cover portion 40 and the rear cover portion 42 together. The magnetic members can be built into the front cover portion 40 and/or into the rear cover portion 42.

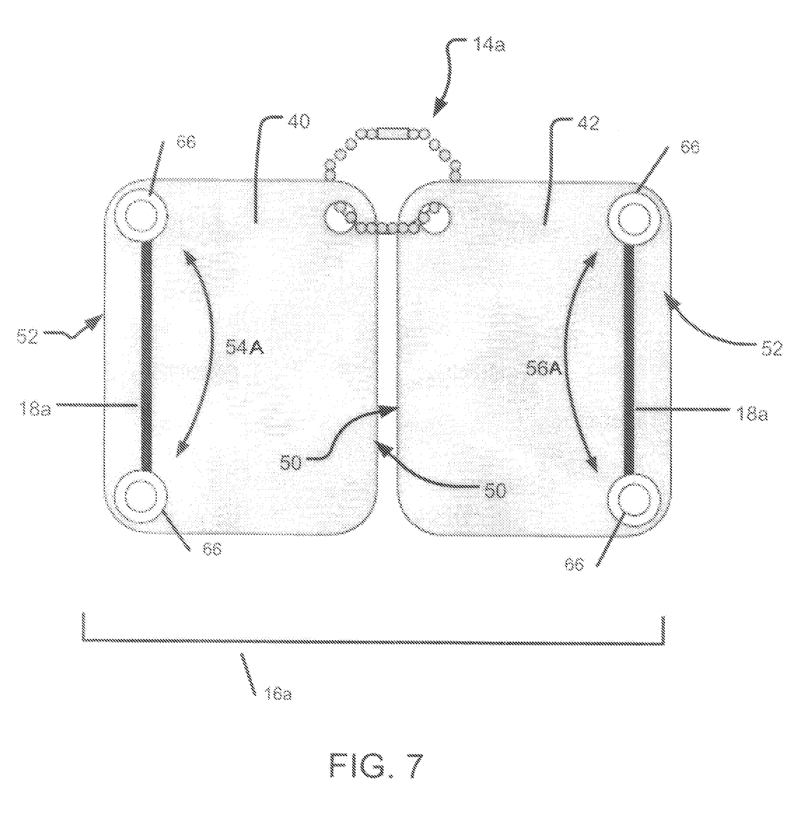

In another example, a cover member 16a can include the two pairs of apertures 54A, 56A. The apertures 54A, 56A can be finished with eyelets 66 to which band members 18a can connect, as shown in FIG. 7. The band members 18a can secure to the apertures 54A, 56A on the front cover portion 40 and the rear cover portion 42 without using the post members 62 (FIG. 2). With reference to FIGS. 2 and 7, when the cover member 16, 16a is open or hanging on a refrigerator, the band members 18, 18a can be wrapped around portions of the meal planning cards 12 on the left and right sides of the cover member 16, 16a to secure the meal planning cards 12 on both sides of the cover member 16, 16a. When closed, one (or two) of the band members 18, 18a can be wrapped around the entire meal planner system 10 to secure it from opening. It will be appreciated in light of the disclosure that the cover member 16 and the cover member 16a, and the band member 18 and the band member 18a can be used interchangeably throughout the disclosure as applicable. While the front cover portion 40 and the rear cover portion 42 are described above as discrete components that are joined together via a connector, in some configurations, the front cover portion 40 and the rear cover portion 42 may be integrally formed and/or may flexible portion to enable the front cover portion 40 and the rear cover portion 42 to move relative to each other between an open position and a closed position.

In operation, the meal planning cards 12 can be secured between the front cover portion 40 and the rear cover portion 42 of the cover member 16. The meal planning cards can have an aperture 68 that can accept the connector member 14 and additionally connect the meal planning card 12 to the cover member 16. Because the meal planning cards 12 are secured in the cover member 16, the meal planning cards 12 can be protected. Moreover, the cover member 16 can attach to a refrigerator door or other location in a kitchen during cooking or while following meal planning directions found on the meal planning cards 12.

The meal planning cards 12 can include a four week or a one month set that can include approximately seventy (70) to eighty-one (81) of the meal planning cards 12, for example. A first portion of the meal planning cards 12 can provide a four week or monthly shopping list of stock items including non-perishable, long shelf-life items, and/or items packaged for room temperature storage. The four week or monthly shopping list can allow the user to stock purchased items from a store, e.g., pantry and dry items. The first portion of the meal planning cards 12 can be a single meal planning card.

A second portion of the meal planning cards 12 can show weekly shopping lists. Each of the weekly shopping lists can provide a list of fresh and/or perishable items to be used in weekly menus and consumed by the user. For example, the weekly shopping lists can provide a plurality of fresh items to be consumed during the week. The second portion of the meal planning cards 12 can be four (4) or five (5) of the meal planning cards 12, for example.

A third portion of the meal planning cards 12 can be individually provided for a specific meal such that one meal can be provided on one of the meal planning cards 12. The subset of the meal planning cards 12 that includes the sixty (60) to seventy-five (75) can include meal planning cards 12 that provide, for example, four (4) or five (5) sets of breakfasts, lunches, dinners, and/or snacks. Each of the sets may correspond to a week's worth of meals. The meal planning cards 12 can be configured to include both snacks and breakfasts for a single day on one of the meal planning cards. The weekly shopping lists may include only enough food items to enable a user to prepare all of the breakfasts, lunches, dinners and/or snacks for the corresponding week. While the meal planning cards 12 are described above as providing four (4) or five (5) sets of breakfasts, lunches, dinners, and/or snacks, in other configurations, the meal planning cards 12 may provide any other number of sets of breakfasts, lunches, dinners, and/or snacks.

Each of the meal planning cards 12 that individually represent a single meal can have the ingredients for that meal on one side of the meal planning card 12 while directions for the meal preparation for that meal can be provided on the same or opposite side of the meal planning card 12. An ingredient list on the subset of the meal planning cards 12 can also serve as a basis for preparing or augmenting shopping lists, whether for fresh or stock items. The third portion of the meal planning cards 12 can include sixty (60) to seventy-five (75) of the meal planning cards 12, for example.

The one month set of the meal planning cards 12 can also include a fourth portion of the meal planning cards 12 that can be configured to show pictures of some or all of the meals included for the user in the four week or one month set of the meal planning cards 12.

In one example, all of the meal planning cards 12, whether used for shopping or meal preparation can be color-coded with two colors. The first color code can be on the upper edge of the meal planning card 12. For example, the first color code can differentiate each week of a year, i.e., 52 different colors for each week of a year. In other configurations, all of the meal planning cards may correspond to a season of the year (i.e., spring, summer, fall or winter). The color code can also include a sign with a name of the month and sequential order of weeks and can also include a day of the week.

The second color code can be on the opposite vertical edge (i.e., right for the front sides of meal planning cards and left for the back sides of meal cards) and can differentiate the type of meal planning card 12 such as one color for the weekly shopping list, one color for breakfasts, one color for lunches, and one color for dinners.

It will be appreciated in light of the disclosure that the meal planning cards 12 can be used as a weekly meal planner or independent (i.e., single) meal planning cards 12. When the meal planning cards 12 are used as the weekly meal planner, it can be shown that the user can receive increased benefits when the meal planner system 10 is used for an extended period of time. In addition, monthly and/or weekly shopping lists provided in the meal planning cards 12 can be shown to help manage the household food budget. Moreover, the meal planning cards 12 permit the user to use the same foods in multiple meals as well as reusing leftovers to create new meals which can be shown to save time and money. In doing so, the meal planning cards 12 can facilitate the user's consumption of freshly purchased items (e.g., perishable produce) within a period of a week and the consumption of all of the stock items within a period of one or more months, for example.

One or more of the recipes included in the meal planning cards 12 may include multiple components or sub-meals. Such a recipe could include a meat component, a pasta or grain component (e.g., rice, couscous, noodles, etc.), and a sauce component, for example, and/or any other component. The recipe may prompt the user to prepare an additional quantity of one or more of the components in addition to a quantity of that component that is needed for the particular meal corresponding to that recipe. The recipe may prompt the user to save the additional quantity of the one or more components for use in a different recipe corresponding to a specified subsequent meal. In this manner, the meal planner system 10 can reduce the amount of time required to prepare the subsequent meal.

The shopping lists provided in the weekly meal planner sets of the meal planning cards 12 can provide detailed amounts (i.e., measurements of weight and/or volume) of each of the fifteen (15) items (or any other number of items) that can be used during a week. The weekly recipes can include detailed ingredient lists with exact measurements for each item. When the user makes use of the meal planner system 10, the user can finish up all fifteen (15) items during a week and therefore not have wasted any food. The meal planner system 10 will not only help control monthly and weekly grocery budgets by adding/buying only fifteen (15) fresh items each week, but the meal planner system 10 is also configured to avoid any food waste. In this regard, the meal planner system 10 provides ideas on how to use the same foods during a week and to prepare creative meals in that week. Similarly, the same monthly stock items can be used in the recipes over the weeks and months, while using the meal planner system 10. At the same time, new stock items can be introduced for variety and then can be repeated over weeks and months, as applicable.

In a further example, the meal planning cards 12 need not be solely used as an entire and unbreakable set but one or more meal planning cards 12 can be also used independently of other meal planning cards 12 or each of the meal planning cards 12 can be selected randomly and used in meal preparation and can be used as a grocery shopping list. The meal planning cards 12 that provide meal preparation information can be shuffled (and re-shuffled) so that the user can randomly draw one of the meal planning cards 12 by the meal type color (i.e., breakfast, lunch, or dinner). After the meal preparation, the user can return the already drawn meal planning card 12 to the rest of the meal planning cards 12 to select at random again or to be employed with the weekly or monthly subsets of the meal planning cards.

It will be appreciated in light of the present disclosure, that the meal planner system 10 can permit the user to carry everything on the connector member 14. In this regard, the meal planner system 10 can be carried in a purse or pocket and the propensity for leaving the meal planner system 10 behind can be reduced. The user need not worry or plan in advance, as the meal planner system 10 can always provide information to plan, prepare and track each meal.

The meal planning cards 12 can also provide a calorie count for each ingredient and nutritional information (e.g., food-energy value, fat, protein, sodium, sugar, etc.) for each meal. All of the meals corresponding to a particular day may include nutritional values adding up to predetermined daily nutritional values. In this regard, the user can control calorie intake, can easily change portions, add or skip certain ingredients according to the user's caloric needs. All recipes on the meal planning cards 12 can maximize the consumption of the seasonal foods and healthiest foods, such as antioxidants, Superfoods, healthy fats, etc.

In one example, the user can subscribe to a service that can provide additional meal planning cards 12. The subscription service can provide the meal planning cards on a monthly basis over a subscription year or other suitable period. Over a year period, the meals on the meal planning cards 12 can be based on the four seasons to highlight food particularly healthy and ripe for that season.

The meal planner system 10 can further be configured so the user can focus on specialty foods such as will be followed by the additional antioxidant foods, kid's meals, vegetarian, international cuisine, weekend meals, gluten-free meals, diabetic meals, etc.

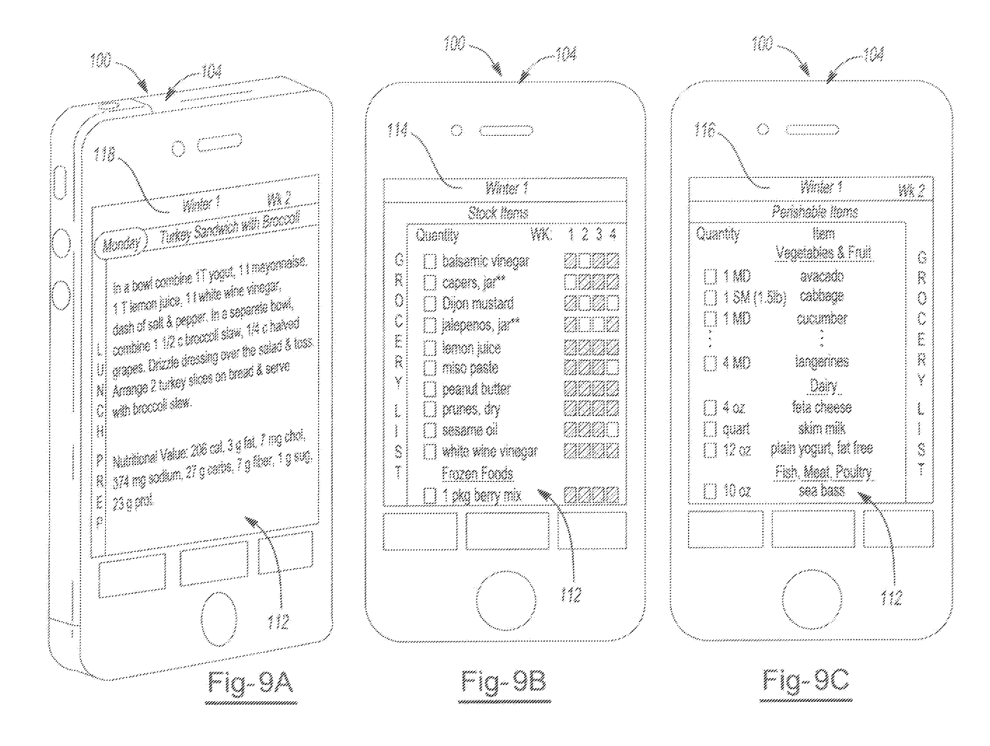

With reference to FIGS. 9A-11, a meal planner system 100 is provided. The meal planner system 100 may include a program or application 102 operable on an electronic device 104 such as a mobile phone (e.g., a smartphone), a desktop computer, a laptop computer, a personal digital assistant (PDA), an iPod®, and/or an iPad®, for example, and/or any other mobile computing device. The meal planner system 100 may be downloadable and stored in a memory unit of the electronic device 104 or the meal planner system 100 could be internet-based such that a user accesses the meal planner system 100 on a website.

The meal planner system 100 may be generally similar to the meal planner system 10 described above and may display a plurality of subsets of meal planning cards 112. As described above with reference to the meal planner system 10, the plurality of subsets of meal planning cards 112 may include a plurality of monthly stock-item grocery lists 114, a plurality of subsets of weekly perishable-item grocery lists 116 and a plurality of subsets of meal recipe cards 118. As shown in FIGS. 9A-9C, the stock-item grocery lists 114, perishable-item grocery lists 116 and meal recipe cards 118 may be displayed on the electronic device 104. The stock-item grocery lists 114, perishable-item grocery lists 116 and meal recipe cards 118 may be formatted specifically for a particular electronic device such as a laptop or desktop computer, a smartphone and/or other mobile device. Additionally or alternatively, the stock-item grocery lists 114, perishable-item grocery lists 116 and meal recipe cards 118 may be formatted for printing (i.e., a “printer-friendly” format).

The number and content of the monthly stock-item grocery lists 114, weekly perishable-item grocery lists 116 and meal recipe cards 118 may be substantially similar to the meal planning cards 12 described above. Briefly, each of the monthly stock-item grocery lists 114 may include a list of long shelf-life grocery items that may be used in the preparation of meals corresponding to a four week period, for example. Each of the four weeks may correspond to one of the weekly perishable-item grocery lists 116. Each of the weekly perishable-item grocery lists 116 may include grocery items that may be used in the preparation of meals during a corresponding week. The meal recipe cards 118 may include an ingredient list and preparation steps for meals for some or all of the days in the corresponding week that include the grocery items from the corresponding stock-item grocery list 114 and/or weekly perishable-item grocery list 116. The recipes corresponding to all of the meal recipe cards 118 for a particular week may consume all of the grocery items on the corresponding weekly perishable-item grocery list 116. The recipes corresponding to all of the meal recipe cards 118 for a particular four-week period may consume all of the grocery items on the corresponding stock-item grocery lists 114. It should be appreciated that while the stock-item grocery lists 114 are described as corresponding to a four week or one month period and the perishable-items grocery lists 116 are described as corresponding to a one week period, these time periods can be varied without departing from the scope of the present disclosure.

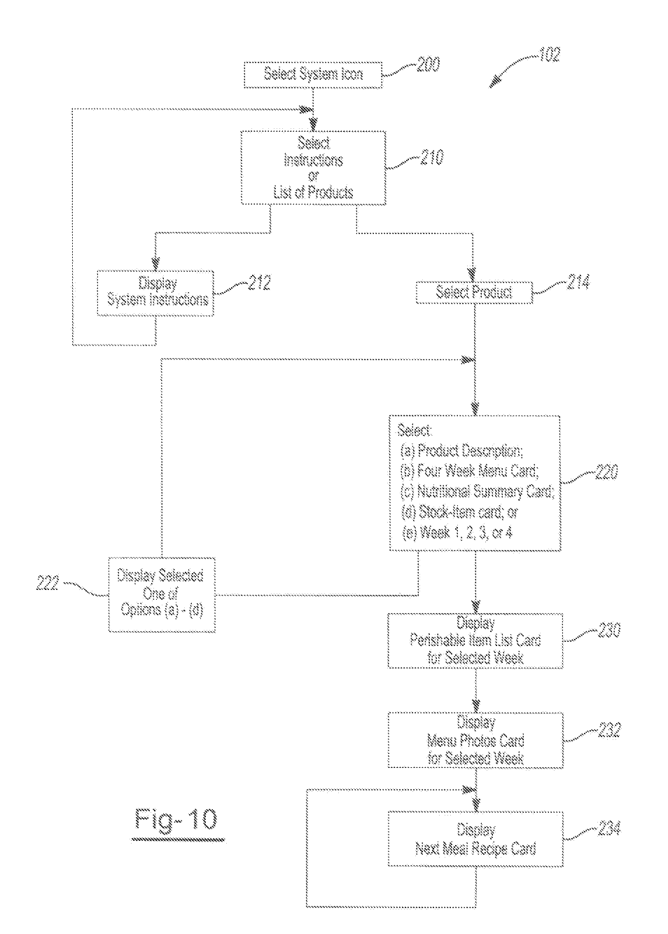

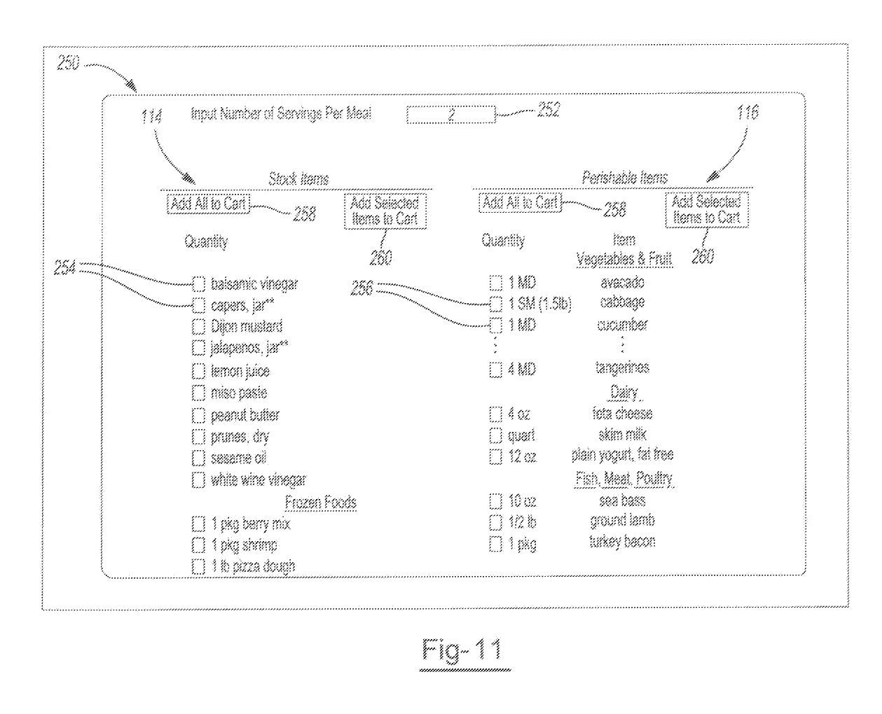

With reference to FIG. 10, operation of the program 102 will be described in detail. It will be appreciated that code defining the program 102 and/or the user interface of the program 102 may be customized for operation on a particular operating system and/or a particular electronic device 104. A hyperlink or icon corresponding to the program 102 and displayed on the electronic device 104 may be selected, as shown at step 200, to start or launch the program 102 on the electronic device 104. Then, at step 210, the user may be prompted to select a first hyperlink or button corresponding to instructions for the meal planner system 100 or a second hyperlink or button corresponding to a list of products (e.g., subsets of cards 112 corresponding to a particular season of the year, or a particular version or release of the meal planner system 100). If the user selects the hyperlink corresponding to instructions for the meal planner system 100, the program 102 may display instructions detailing navigation through the program 102 and/or recommended usage of the meal planner system 100, as shown at step 212. The program 102 may then return to step 210. If the user selects the hyperlink corresponding to the list of products, the program 102 may display the list of products so that the user may select one of the products, as shown at step 214.

Once the user has selected one of the products at step 214, the program 102 may display a list of options from which the user may select, as shown at step 220. The list of options may include (a) a product description; (b) a four week menu card; (c) a nutritional summary card; (d) one of the stock-item grocery lists 114 corresponding to a four week period; or (e) one of four subsets of cards 112 each including the perishable-item grocery list 116 and the subset of meal recipe cards 118 corresponding to one of the weeks of the four week period. If the user selects any of options (a)-(d), the program 102 may display information corresponding to the selected option at step 222. Then the program 102 may return to step 220 to allow the user to select another of options (a)-(e).

If the user selects option (e) at step 220, the program 102 may proceed to step 230 and display the weekly perishable-item list 116 corresponding to a selected one of the four weeks of the product chosen at step 214. As described above, the user may purchase grocery items from the weekly perishable-item list 116 for use in preparation of the recipes for an upcoming week. The program 102 may display one or more photographs of meals corresponding to the meal recipe cards 118 for the upcoming week, as shown at step 232.

The program 102 may display a meal recipe card 118 corresponding to an upcoming or current day, as shown at step 234. The user may refer to the meal recipe card 118 while preparing the corresponding meal. At this point, the user may either advance the program 102 to the next meal recipe card 118 or exit the program until a later date or time. The program 102 may save the place or card 112 at which the user last exited the program 102 such that when the user reenters the program 102 at the later date or time, the program 102 may quickly return the user to the last card 112 viewed or the next card 112 (e.g., the card 112 corresponding to the next meal) in the sequence of cards 112.

In some configurations, upon selecting one of the four weeks of option (e) at step 220, the program 102 may prompt the user to select an order or arrangement of the sequence in which the cards 112 are displayed. For example, the cards 112 may be arranged by day, i.e., the weekly perishable-item grocery list 116 may be displayed first, then the photographs of one or more of the meals, and then the meal recipe cards 118 may be arranged by day of the week. As another example, the user may choose to arrange and view the meal recipe cards 118 by meal type, i.e., breakfast, lunch, dinner and snacks.

Referring now to FIG. 11, in some configurations, the meal planner system 100 and the program 102 may be linked to or integrated into a grocery retailer's website. In such configurations, the program 102 may be configured to accept online orders for the grocery items listed on the stock-item grocery lists 114 and/or the perishable-item grocery lists 116 that the user may place using an order form 250 displayed on the electronic device 104 by the program 102. The program 102 may communicate a completed order form 250 to the grocery retailer, who may then gather the ordered grocery items and ship or deliver the grocery items to the user's residence or other selected location. In addition to the completed order form, the program 102 may collect and transmit payment information (e.g., credit or debit account information) to the grocery retailer or link the user to a third-party payment processing system such as PayPal®, for example. In some configurations, the grocery retailer (or other business entity) may sell subscriptions for use of the meal planner system 100 via the retailer's website and/or the program 102.

The order form 250 may display the stock-item grocery list 114 and/or the perishable-item grocery list 116 for a selected time period. The order form 250 may include a first input field 252 and a plurality of second input fields 254. The first input field 252 may allow a user to input the number of servings of each meal that the user chooses to make. Default quantities of each of the listed grocery items may be automatically updated to accommodate the selected number of servings. Each of the plurality of second input fields 254 may correspond to a particular grocery item and may allow the user to select quantities of the particular grocery item that the user chooses to purchase. In this manner, the program 102 may allow the user to order selected grocery items in bulk, if desired. The order form 250 may also include first buttons 258 that allow the user to add all listed grocery items to a virtual shopping cart and second buttons 260 that allow the user to add only selected grocery items to the virtual shopping cart.

In some configurations, the order form 250 may be configured to allow the user to select a preferred brand for one or more of the grocery items. Additionally or alternatively, the order form 250 may be configured to allow the user to replace a listed grocery item for a different preferred grocery item. For example, the user could replace pork with chicken, replace spaghetti with angel hair pasta, or replace all meats and/or animal products with vegetarian or vegan substitutes.

In some configurations, the program 102 may allow the user to setup a schedule of recurring grocery item deliveries, in which the program 102 may automatically place an order with the grocery retailer for the grocery items that will be used in preparing the meals on the meal recipe cards 118. The program 102 may be configured to time the orders and deliveries so that the grocery items arrive at the user's residence in time to prepare the corresponding meals for upcoming days.

The program 102 may be configured to allow a user to create an online account to which the user may logon using dedicated username and password. The user may register (or sign up) for usage of the meal planner system 100 for a predetermined time period such as 4 weeks, 13 weeks, or one or more years, for example. It should be appreciated that the program 102 may allow the user to register for usage of the meal planner system 100 for a lifetime or other indefinite period.

Upon establishing the account, the user may login to the account and review and select one or more individual meal recipes or groups of meal recipes for one or more days, weeks, months or years of the predetermined time period for which the user has registered. Weekly menu plans may be sorted by type of meal (i.e., breakfasts, lunches, dinners, and snacks) or by day of the week. The program 102 may enable the user to input a desired number of servings and follow a predetermined sequence of meals or select specific meal recipes to customize a meal plan. The program 102 may generate one or more stock-item grocery lists 114, perishable-item grocery lists 116 and meal recipe cards 118 (including photographs and/or nutritional information, for example) based on the user's selections. Additionally or alternatively, the program 102 may be configured to customize and generate the order form 250 based on the user's selections.

The foregoing description of the many aspects of the present teachings has been provided for purposes of illustration and description. It is not intended to be exhaustive or to limit the disclosure. Individual elements or features of a particular aspect are generally not limited to that particular example, but, where applicable, are interchangeable and can be used in a selected aspect of the present teachings, even if not specifically shown or described. The same may also be varied in many ways. Such variations are not to be regarded as a departure from the present teachings, and all such modifications are intended to be included within the scope of the present teachings.

What is claimed is:

1. A system comprising:
a plurality of subsets of meal planning cards, each of said subsets of meal planning cards corresponding to one of a plurality of predetermined time periods and including a first card and a plurality of second cards;
said first card including a first list of food items corresponding to said one of said predetermined time periods;
each of said second cards including one of a plurality of recipes corresponding to one of a plurality of meals during said one of said predetermined time periods, said one of said plurality of recipes including at least one of said food items from said first list of food items.

2. The system of claim 1, wherein preparation of all of said plurality of recipes associated with all of said plurality of second cards consumes all of said food items from said first list of food items.

3. The system of claim 1, further comprising a third card corresponding to at least two of said subsets of meal planning cards, said third card including a second list of food items, at least one of said plurality of recipes incorporating at least one food item from said second list of food items.

4. The system of claim 3, wherein said first list of food items includes fresh food items and said second list of food items includes food items packaged for room temperature storage.

5. The system of claim 1, wherein each of said second cards includes nutritional information regarding a corresponding one of said plurality of recipes.

6. The system of claim 1, wherein a group of said recipes corresponding to all meals in a single day yield a predetermined food-energy value for said single day.

7. The system of claim 1, further comprising a connector engaging said plurality of subsets of meal planning cards.

8. The system of claim 7, further comprising a case adapted to receive said plurality of subsets of meal planning cards, said case including a first portion, a second portion, and a central portion that is foldable to allow said first and second portions to move relative to each other, said first portion including a first retaining member adapted to secure at least one of said plurality of subsets of meal planning cards, said second portion including a second retaining member adapted to secure at least another of said plurality of subsets of meal planning cards.

9. The system of claim 8, wherein said case and said plurality of subsets of meal planning cards are sized to enable a user to carry said case and said plurality of subsets of meal planning cards in one of a purse and a clothing pocket.

10. The system of claim 1, wherein at least one of said subsets of meal planning cards includes an elastomeric band selectively engaging at least some of said first and second cards to retain said at least some of said first and second cards in a stored position.

11. The system of claim 1, wherein the system corresponds to a season of a year.

12. The system of claim 1, wherein said subsets of meal planning cards include color coding indicating a particular meal.

13. The system of claim 1, wherein at least one of said subsets of meal planning cards are displayed on a screen associated with an electronic device.

14. The system of claim 13, further comprising a program operable on said electronic device, said program being configured to allow a user to view and manipulate said first, second and third grocery lists and said first and second recipes.

15. The system of claim 1, wherein a first meal corresponding to a first one of said recipes includes a first quantity of a meal component and a second meal corresponding to a second one of said recipes includes a second quantity of said meal component, wherein said first one of said recipes prompts a user to prepare said first and second quantities of said meal component during preparation of said first meal.

16. A meal planning system comprising:
a stock-item grocery list;
a first subset of cards including a first multi-day grocery list and a plurality of first meal cards associated with said first multi-day grocery list, each of said first meal cards including one of a first plurality of recipes that include food items from at least one of said stock-item grocery list and said first multi-day grocery list, said first multi-day grocery list listing enough food items to prepare said recipes on all of said first meal cards; and
a second subset of cards including a second multi-day grocery list and a plurality of second meal cards associated with said second multi-day grocery list, each of said second meal cards including one of a second plurality of recipes that include food items from at least one of said stock-item grocery list and said second multi-day grocery list, said second multi-day grocery list listing enough food items to prepare said recipes on all of said second meal cards.

17. The meal planning system of claim 16, wherein said first and second multi-day grocery lists include fresh food items and said stock-item grocery list includes food items packaged for room temperature storage.

18. The meal planning system of claim 16, wherein each of said first and second meal cards includes nutritional information regarding a corresponding one of said recipes.

19. The meal planning system of claim 16, wherein a group of said recipes corresponding to meals in a single day yield a predetermined food-energy value for said single day.

20. The meal planning system of claim 16, further comprising a connector engaging said stock-item grocery list and said first and second subsets of cards.

21. The meal planning system of claim 20, further comprising a case adapted to receive said stock-item grocery list and said first and second of subsets of cards, said case including a first portion, a second portion, and a central portion that is foldable to allow the first and second portions to move relative to each other, said first portion including a first retaining member adapted to secure at least a portion of one of said first and second subsets of cards, said second portion including a second retaining member adapted to secure at least another portion of one of said first and second subsets of cards.

22. The meal planning system of claim 21, wherein said case and said first and second subsets of cards are sized to enable a user to carry said case and said first and second subsets of cards in one of a purse and a clothing pocket.

23. The meal planning system of claim 16, further comprising an elastomeric band selectively engaging at least a portion of said first and second subsets of cards to retain at least said portion in a stored position.

24. The meal planning system of claim 16, wherein the stock-item grocery list and said first and second subsets correspond to a season of a year.

25. The meal planning system of claim 16, wherein said first and second meal cards include color coding for at least one of indicating a particular meal and differentiating said first and second meal cards from each other.

26. The meal planning system of claim 16, wherein at least one of said stock-item grocery list, said first subset of cards, and said second subset of cards are displayed on a screen associated with an electronic device.

27. The meal planning system of claim 26, further comprising a program operable on said electronic device, said program being configured to allow a user to view and manipulate said first, second and third grocery lists and said first and second recipes.

28. The system of claim 16, wherein a first meal corresponding to a first one of said first recipes includes a first quantity of a meal component and a second meal corresponding to a second one of said first recipes includes a second quantity of said meal component, wherein said first one of said first recipes prompts a user to prepare said first and second quantities of said meal component during preparation of said first meal.

29. A system comprising:
a first grocery list;
a second grocery list associated with said first grocery list;
a plurality of first recipes associated with said second grocery list, each of said first recipes including food items from at least one of said first and second grocery lists, said second grocery list listing enough food items to prepare said first recipes;
a third grocery list associated with said first grocery list; and
a plurality of second recipes associated with said third grocery list, each of said second recipes including food items from at least one of said first and third grocery lists, said third grocery list listing enough food items to prepare said second recipes.

30. The system of claim 29, wherein said first grocery list corresponds to a first predetermined time period, said second grocery list corresponds to a second predetermined time period, and said third grocery list corresponds to a third predetermined time period, said second and third predetermined time periods being within said first predetermined time period.

31. The system of claim 30, wherein each of said plurality of first recipes corresponds to a meal in said second predetermined time period, and each of said plurality of second recipes corresponds to a meal in said third predetermined time period.

32. The system of claim 30, wherein said first predetermined time period is four weeks and each of said second and third time periods is one week.

33. The system of claim 29, wherein said first, second and third grocery lists and said first and second recipes are selectively displayed on an electronic device.

34. The system of claim 33, wherein said electronic device is a hand-held mobile device.

35. The system of claim 33, further comprising a program operable on said electronic device, said program being configured to allow a user to view and manipulate said first, second and third grocery lists and said first and second recipes.

36. The system of claim 29, wherein said first, second and third grocery lists and said first and second recipes are printed on cards, said cards being connected to each other in a predetermined arrangement.

37. The system of claim 29, wherein said first grocery list includes a list of substantially long shelf-life grocery items and said second and third grocery lists include lists of perishable grocery items.

38. The system of claim 29, further comprising an order form from which a user may purchase grocery items from at least one of said first, second and third grocery lists.

39. The system of claim 29, wherein a group of said first recipes corresponds to meals in a single day and yields a predetermined food-energy value for said single day.

40. The system of claim 29, wherein a first meal corresponding to a first one of said first recipes includes a first quantity of a meal component and a second meal corresponding to a second one of said first recipes includes a second quantity of said meal component, wherein said first one of said first recipes prompts a user to prepare said first and second quantities of said meal component during preparation of said first meal.
